(19) United States
(12) Patent Application Publication
(10) Pub. No.: US 2010/0289334 A1
(43) Pub. Date: Nov. 18, 2010

(54) INVERTER

(76) Inventors: Heribert Schmidt, Freiburg (DE); Bruno Burger, Freiburg (DE)

Correspondence Address: SCHWEGMAN, LUNDBERG & WOESSNER, P.A., P.O. BOX 2938, MINNEAPOLIS, MN, 55402, US

(21) Appl. No.: 12/665,372

(22) PCT Filed: May 20, 2008
(86) PCT No.: PCT/EP08/04124

§ 371 Date: Jul. 1, 2010

(30) Foreign Application Priority Data
Jun. 22, 2007 (DE) 10 2007 029 767.1

(51) Int. Cl. H02J 3/00; H02M 7/04

(52) U.S. Cl. 307/43; 363/123

(57) ABSTRACT

The invention relates to an inverter for converting DC voltage into an alternating voltage or an AC voltage, comprising a first series connection that is connected to the DC voltage terminals and comprises at least one first electronic switch and a first inductance for accumulating the interconnected energy and a plurality of second electronic switches for transferring the accumulated energy. A second inductance is tightly coupled to the first inductance, both inductances supplying their energy to a filter capacitor that is arranged in parallel to the AC voltage terminal, respectively via a second electronic switch. Said inverter also comprises a shunt arm that comprises a series connection from a third clocked switch and a capacitor for receiving the energy from the leakage inductances and that is connected to the first inductance and the series connection of one of the second switches and the second inductance. The invention also relates to the use thereof, for example, with a solar generator for introducing into a public network.

The invention relates to an inverter for converting a direct voltage into an alternating voltage or an alternating current according to the preamble of the main claim.

Inverters for converting direct voltage into an alternating voltage or an alternating current are generally known, a differentiation being made with these inverters between inverters which are DC-coupled, i.e. transformerless inverters, and those which are decoupled, i.e. transformer-inverters. The highest efficiencies are achieved with transformerless inverters in a full-bridge circuit without step-up converters, such as are described for example in DE 102 21 592 A1. In these circuits, the potential of the source fluctuates relative to earth potential with mains frequency and half mains voltage. There is therefore a restriction in the applicability of these concepts in the case of sources with a high leakage capacitance relative to earth potential, as is the case for example with solar generators of a specific technology, in particular thin-film modules. Furthermore, with conventional transformerless inverters without a step-up converter, the input voltage range is delimited at the bottom by the voltage at least required for the supply at the level of the amplitude of the mains voltage, i.e. approx. 325 V with an effective value of 230 V.

Furthermore, transformerless concepts are known for example from DE 196 42 522 C1 and from DE 197 32 218 C1, in which a terminal of the solar generator is connected in a fixed manner to the neutral conductor and hence has a fixed potential relative to earth potential. As a result, due to the principle, no leakage currents can flow even with arbitrarily high leakage capacitances.

In DE 196 42 522 C1, an inductance coil is applied to an input voltage in a first timing portion via two switches and is buffered by an input capacitor and energy is stored in the inductance coil. In the second timing portion, according to the polarity of the voltage at an output capacitor which essentially corresponds to the mains voltage, a plurality of switches is configured such that the energy stored in the inductance coil can be output to the output via diodes and said switches. It is disadvantageous with this known circuit arrangement that the current flows in the individual timing phases through a large number of semiconductor switches and diodes. In the first timing phase, two switches are always in the current path, in the second timing phase during the positive half-wave there are two switches and two diodes and, in the negative, two switches and one diode. As a result, high losses and correspondingly poor efficiency are produced. In addition, the switches, together with the associated actuations, represent a significant complexity and reduce the reliability. These inverters are distinguished therefore by high complexity and hence poor efficiency, high costs and also reduced reliability.

The object therefore underlying the invention is to produce an inverter for converting a direct voltage into an alternating voltage or an alternating current from a direct voltage source which is unipolar with respect to a neutral conductor, which offers high efficiency and is based on simple, economical, reliable structures which can be controlled easily by control technology.

This object is achieved according to the invention by the characterising features of the main claim in conjunction with the features of the preamble.

Advantageous developments and improvements are possible by means of the measure indicated in the sub-claims.

As a result of the fact that, in addition to the inductance connected to the first timed electronic switch, a second inductance is provided in close coupling to the first inductance and the two inductances respectively output their energy to a filter capacitor which is in parallel with the alternating voltage terminal via one of two second electronic switches, a shunt arm which has a series circuit comprising a third timed switch and a capacitor for receiving energy from leakage inductances being connected to the first inductance and to the series circuit comprising one of the second switches and the second inductance, the number of semiconductor switches is reduced. In comparison to the state of the art mentioned above, the current flows in the first timing phase only through one semiconductor switch, in the second timing phase during both half-waves through respectively one semiconductor switch and one diode, as a result of which the efficiency and the reliability are increased. By providing the shunt arm, the energy stored in the unavoidable leakage inductance of the first inductance is received and transferred specifically to the output and no unnecessary oscillations within the circuit, associated with losses, take place. This measure leads to a further notable increase in efficiency, one of the main aims in the development of inverters for photovoltaics. Furthermore, the insertion of the switch in the shunt arm has the result that the capacitor in the half-wave in which the described function is not required does not charge up to a high voltage. This would have the result that, during a reversal in the mains polarity, a high discharge current pulse would flow briefly.

It is particularly advantageous that two components which limit excess voltage, e.g. varistors, respectively are connected to an inductance and a diode since these can receive energy stored in the inductances if, with an emergency switch-off of the inverter, all the switches are opened at the same time. Consequently, the semiconductors are prevented from being destroyed as a result of extreme excess voltages on the semiconductors, as in the state of the art. Since the components which limit excess voltage are not subjected to a pulse voltage in the arrangement according to the invention, varistors can be used. The use of these economical and robust components would not however be allowed in timed circuits since varistors have a very high parasitic capacitance which would have to be recharged with every cycle. In the state of the art, in addition decoupling diodes or so-called TVS diodes (transient voltage suppressor diodes (TransZorb diodes)) are used, which are however more costly. By use according to the invention of the varistors, both the reliability can be increased and the cost can be reduced.

The circuit arrangement according to the invention can also have a multiphase design, e.g. three-phase for supplying the normal public three-phase mains. Advantageously, one or more solar generators, fuel cells, batteries or the like can be used as direct voltage source.

In an advantageous development, the circuit has a complementary construction and the positive pole of the solar generator is connected to the neutral conductor, as a result of which all the cells of the modules of the solar generator have a negative potential relative to earth potential, which has an advantageous effect on the efficiency with specific types of solar cells.

An embodiment of the invention is represented in the drawing and is explained in more detail in the subsequent description. There are shown:

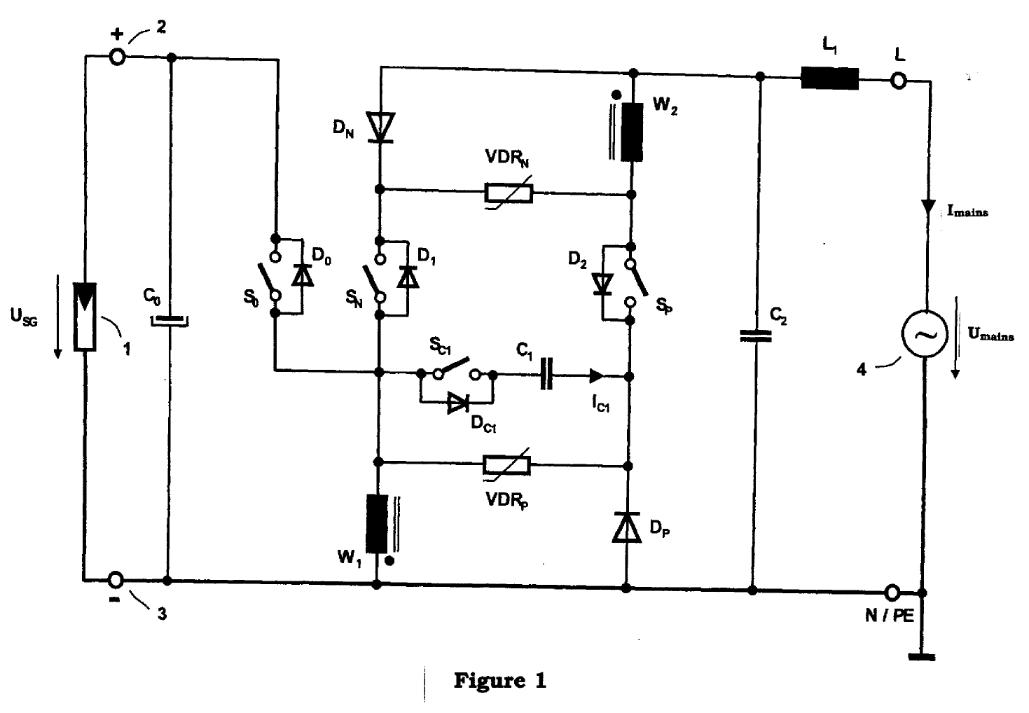

FIG. 1 the configuration, with respect to the circuitry, of an embodiment of the invention,

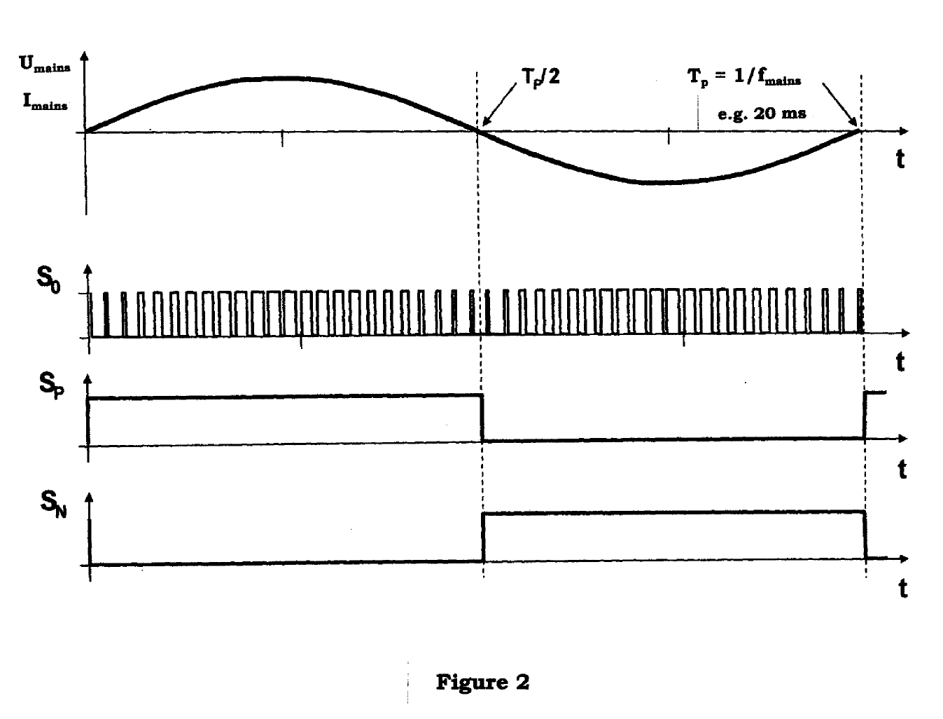

FIG. 2 diagrams of the pulse patterns occurring at the switches in the circuit arrangement according to FIG. 1, and

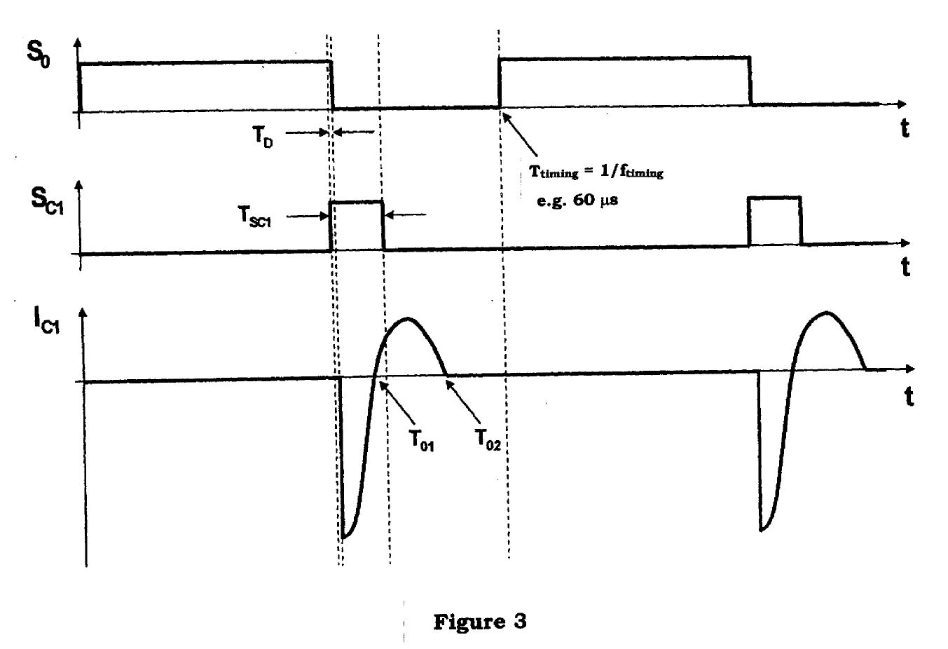

FIG. 3 pulse diagrams on an enlarged scale of the first switch and of the third switch, and also a diagram for the current of the capacitor in the shunt arm.

The circuit arrangement, configured as an inverter and illustrated in FIG. 1, has a direct voltage source which, in the embodiment, is a solar generator 1 which is applied by its terminals on a positive line 2 and a neutral or earth conductor 3. This solar generator delivers an input direct voltage U_{SG}.

Parallel to the solar generator 1, an input capacitor C₀ which buffers the input voltage U_{SG} is provided. Between the lines 2, 3 there is situated the series circuit of a first inductance W₁ and of a switch S₀ which is timed by a control unit, not illustrated, and can be configured as a transistor, preferably as MOS-FET or as IGBT. The diode D₀ is not required for the actual function of the circuit but is inherently present in the case of MOS-FETs, in the case of IGBTs it must be incorporated in addition and protects these components from negative voltages.

A second switch S_{N} is connected to the connection point between the first switch S₀ and the inductance W₁, a diode D_{N} being in series with the switching path of the switch S_{N}. A diode D₁ is in turn in parallel with the switch, the same applying for the switch S_{N} and the diode D₁ (also for the switch S_{P} and the diode D₂ described further on), as for the switch S₀ and the diode D₀. The anode of the diode D_{N} is connected to the output—or filter capacitor C₂.

A further diode D_{P} is connected by its anode to the neutral conductor 3 and, by its cathode, to a further second switch S_{P} in parallel with a diode D₂ and a second inductance W₂ is connected in series to the switching path of the switch S_{P}, the winding start of the inductance W₂ being likewise connected to the output—or filter capacitor C₂. The inductances W₁ and W₂ are connected to each other.

Between the connection point of the winding end of the first inductance W₁ and of the switch S_{N} and the connection point between the diode D_{P} and the switch S_{P}, a shunt arm which comprises the series circuit of a switch S_{C1} and a capacitor C₁ is disposed, a diode D_{C1} being connected in parallel with the switching path of the switch S_{C1}.

The inductances W₁, W₂ supply, via the switches S_{N} and S_{P}, an output—or filter capacitor C₂ which is applied on the neutral conductor 3 by a terminal and, by the other terminal together with the second inductance W₂ and the diode D_{N}, is connected to a smoothing—or supply choke L₁, the other terminal of which is connected to one of the phases L of the mains 4 into which an alternating current is intended to be supplied, the mains voltage being designated with Uₘₐᵢₙₛ. The neutral conductor 3 characterised with N/PE likewise forms an alternating voltage output terminal.

The two connected inductances W₁, W₂ have energy storing properties, the inductance W₁ being used twice over, namely for supplying energy and for producing an inverted output voltage relative to the potential of the neutral conductor 3. The windings of the inductances W₁, W₂ are connected to each other via a coupling factor k (0<k<1).

An advantageous dimensioning is produced if the voltages induced in the two windings are equally large with respect to size. This is achieved by a choice of the winding ratio W₁/W₂, k requiring to become W₂/W₁=1.

Between the winding end of the first inductance W₁ and the cathode of the diode D_{P}, a first varistor (Voltage Dependent Resistor VDR) VDR_{P} is connected and a second varistor VDR_{N} is connected to the cathode of the diode D_{N} and to the winding end of the second inductance W₂.

In FIG. 2, the pulse diagrams of the switches S₀, S_{P} and S_{N} and also the mains voltage or the mains current are represented with a period of for example T_{P}=20 ms.

The switch-on duration of the switch S₀ is adjusted via a control circuit, not shown, e.g. a pulse width modulator PWM, such that a sinusoidal current is set in the output choke L₁, which is then supplied into the public mains supply. In the embodiment, the timing period T_{timing} of the timed switch S₀ can be 60 μs for example.

According to the polarity of the mains voltage 4 or the polarity of the voltage of the capacitor C₂ either the switch S_{N}—in the present case during the negative half-wave—or the switch S_{P} during the positive half-wave are closed permanently, according to FIG. 2. The buffered input voltage U_{SG} is applied via the timed switch S₀ to the first inductance W₁, as a result of which, in the first timing phase in which the switch S₀ is connected through, a temporally increasing current is built up in the inductance W₁, connected to an energy store.

In the negative half-wave, when the switch S₀ is open, the current in the inductance W₁ flows via the closed switch S_{N} and the diode D_{N} into the output—or filter capacitor C₂. The energy which is output in this pulse-like manner to the filter capacitor C₂ is integrated there to form a capacitor voltage and is supplied via the smoothing choke L₁ to the mains 4. The switches S_{P} and S_{C1} are permanently opened and the inductance W₂ is in open circuit.

In the positive half-wave, the switch S_{N} is opened and the switch S_{P} is closed. The energy stored in both inductances W₁, W₂ leads to a positive current flow through the diode D_{P}, through the switch S_{P} and through the inductance W₂ into the capacitor C₂ and correspondingly as above via the smoothing choke L₁ into the mains 4.

In FIG. 3, the mode of operation of the shunt arm with the switch S_{C1}, the diode D_{C1} and the capacitor C₁ is represented. The capacitor C₁ has the task of receiving the energy stored in the unavoidable leakage inductance of the first inductance W₁ and transferring it to the output. In the positive half-wave, as shown in FIG. 3, the switch S_{C1} is closed, for this purpose, shortly before the opening of the switch S₀, i.e. the delay time between switching the third switch S_{C1} on and switching the first switch S₀ off is T_{D}. The switch-on time of the third switch is designated with T_{SC1}. As a result, a current path is produced via the diode D_{P}, the capacitor C₁, the switch S_{C1} and the inductance W₁ so that the energy stored in the leakage inductance of W₁ is transferred to the capacitor C₁ and charges the latter. At the same time, a current is already flowing also, as described above, via the diode D_{P}, the switch S_{P} and the second inductance W₂ into the output.

The capacitor C₁ forms, with the leakage inductance of the first inductance W₁, an oscillating circuit so that the current I_{C1} illustrated at the bottom in FIG. 3 is produced. As can be detected, the current flow direction in the capacitor C₁ is reversed again after a defined time (zero crossing at T₀₁) and an energy flow is effected via the winding W₁, the then conductive diode D_{C1}, the capacitor C₁, the switch S_{P} and the second inductance W₂ into the output. It is thereby essential that the switch S_{C1} is opened after the current direction has reversed and the current flows through the parallel-connected diode D_{C1}. Switching off the switch S_{C1} in this manner can be implemented either in a time-controlled manner because of the fixed temporal courses by the control or regulating unit, not shown, or else however by detection of the current direction in the cross-path. In the case of a time-controlled switching-on of the third switch S_{C1}, the switch-on duration T_{SC1} must be longer than the time T₀₁ up to the first zero crossing of the capacitor current I_{C1} and shorter than the time T₀₂ up to the second zero crossing. In the case of state-dependent actuation, the switch S_{C1} would be switched off by the first zero crossing T₀₁.

As can be detected in FIG. 3, the reversing process ends during the next zero crossing T₀₂ of the current I_{C1} since then the diode D_{C1} is situated in the blocking direction and the switch S_{C1}, as described, has been opened. It is achieved by the described timing that the energy stored in the leakage inductance can be transferred specifically to the output and no unnecessary oscillations associated with losses take place within the circuit. This measure leads to a significant increase in efficiency.

Furthermore, the presence of the switch S_{C1} which is open in the negative half-wave has the result that the capacitor C₁ in the negative half-wave does not charge up to a high voltage via the diode D_{P}. This has the result that, upon changing the mains polarity in which the switch S_{N} is opened and the switch S_{P} is closed, a high discharge current pulse would flow via the circuit formed with the first inductance W₁, the capacitor C₁, the switch S_{P}, the second inductance W₂ and the capacitor C₂.

As can be detected from FIG. 1, the two varistors are connected between respective inductance and respective diode. These have the task of receiving the energy stored in the inductances if, in the case of an emergency shutdown of the inverter, all the switches are opened at the same time. Differently from many normal inverter topologies, no inherent current path, via which the inductance could output its energy in a controlled manner, e.g. via recovery diodes, into any buffer capacitors present, exists with this arrangement. As a result, extreme excess voltages would be produced at the semiconductors which typically would destroy the latter. According to the circuit according to FIG. 1, two paths for the energy dissipation are produced in the case of an emergency shutdown. If the boundary voltage of the VDR resistors is exceeded, then a current flow in the loops with the first inductance W₁, the diode D_{P} and the varistor VDR_{P} and also with the second inductance W₂, the diode D_{N} and the varistor VDR_{N} can take place. In the present case, the economical and robust VDR resistors can be used since they are not subjected to any pulse voltage and the voltage at them changes comparatively slowly with mains frequency, i.e. 50 Hz.

The circuit according to FIG. 1 can have a complementary construction.

The diodes D_{N} and D_{P} can also be configured as electronic switches, the switch corresponding to the diode D_{N} in the negative half-wave being actuated asynchronously to the first switch S₀ and to the switch corresponding to the diode D_{P} in the positive half-wave. As a result, the efficiency can be further increased.

1. An inverter for converting a direct voltage applied to direct voltage terminals into an alternating voltage or an alternating current delivered via alternating voltage terminals, the inverter comprising
a first series circuit which is connected to the direct voltage terminals and comprises at least one first electronic switch and a first inductance for storing the switched-through energy and a plurality of second electronic switches for transferring the stored energy, one of the direct and one of the alternating voltage terminals being situated on a neutral conductor, wherein a second inductance is provided in close coupling to the first inductance, the two inductances respectively outputting their energy to a filter capacitor in parallel with the alternating voltage terminal via a second electronic switch, and a shunt arm which has a series circuit comprising a third timed switch and a capacitor for receiving energy from leakage inductances being connected to the first inductance and to the series circuit comprising one of the second switches and the second inductance.

2. The inverter according to claim 1, wherein the two second electronic switches are respectively in series with a diode and one of the inductances.

3. The inverter according to claim 1, wherein energy is stored in a switching phase of the first timed switch in the magnetic circuit of the inductances and, in the other switching phase, a voltage is induced in both inductances such that a charge current flows into the capacitor via the second switches respectively.

4. The inverter according to claim 1, wherein, as a function of the polarity of the alternating current or of the alternating voltage, the second switches switch alternately.

5. The inverter according to claim 1, wherein a diode is connected in parallel to the third switch.

6. The inverter according to claim 1, wherein the first inductance, on the one hand, is connected to the neutral conductor and, on the other hand, via one of the second switches and a diode is connected to the alternating voltage terminal or to the filter capacitor, and the second inductance, on the one hand, is applied on the neutral conductor via the other of the second switches and a diode and, on the other hand, is connected to the alternating voltage terminal or to the filter capacitor.

7. The inverter according to claim 1, wherein the first and the third switch are actuated in a timed manner such that the third switch is closed shortly before the opening of the first switch.

8. The inverter according to claim 7, wherein the third switch is opened as a function of the current flow direction in the capacitor.

9. The inverter according to claim 1, wherein two components which limit excess voltage are connected for energy dissipation respectively to an inductance and a diode.

10. The inverter according to claim 9, wherein the two components which limit excess voltage are varistors.

11. The inverter according to claim 1, wherein a solar generator, preferably with a plurality of modules, a fuel cell and/or a battery are connected to the direct voltage terminals.

12. The inverter according to claim 1, wherein the direct voltage source configured as solar generator is connected by its negative terminal to the neutral conductor and all of the modules of the direct voltage source have a positive potential relative to the neutral conductor.

13. The inverter according to claim 1, wherein the direct voltage source configured as solar generator is connected by its positive terminal to the neutral conductor and all of the modules of the direct voltage source have a negative potential relative to the neutral conductor.

14. The inverter according to claim 2, wherein the diodes assigned to the second switches are configured as electronic switches.
